(19) United States
(12) Patent Application Publication
(10) Pub. No.: US 2005/0028424 A1
(43) Pub. Date: Feb. 10, 2005

(54) Scent dispensing system for fishing lure

(76) Inventor: Michael M. Poinski, Tallmadge, OH (US)

Correspondence Address: HAHN LOESER & PARKS, LLP, One GOJO Plaza, Suite 300, AKRON, OH, 44311-1076, US

(21) Appl. No.: 10/941,170

(22) Filed: Sep. 14, 2004

Related U.S. Application Data
(63) Continuation-in-part of application No. 10/319,981, filed on Dec. 16, 2002.
(60) Provisional application No. 60/345,094, filed on Jan. 4, 2002.

(51) Int. Cl. A01K 85/01

(52) U.S. Cl. 43/42.06

(57) ABSTRACT

A scent-dispensing device that dispenses scent while the device is pulled through water comprises a cylinder of uniform diameter with a first end and a second end A piston is movably positioned within the cylinder, such that when the body is pulled through the water, water enters the first end of the cylinder and causes movement of the piston toward the second end of the cylinder. As the piston moves toward the second end of the cylinder, scent is forced through the second aperture and into the ambient environment.

The application is a Continuation-in-Part of U.S. application Ser. No. 10/319,981 filed Dec. 16, 2002, which claims priority from Provisional Application No. 60/345,094, filed Jan. 4, 2002, both of which are hereby incorporated herein by reference.

### TECHNICAL FIELD

The present invention relates to fishing lures and, more specifically, to scent-dispensing systems for fishing lures.

### BACKGROUND OF THE INVENTION

Anglers are constantly searching for ways to increase their chances of catching fish. Consequently, many different products, including different types of lures, have been developed that presumably provide anglers with an increased chance of catching fish. Lures have been produced in many different sizes and shapes for use in angling for different types of fish. Additionally, lures have been developed that move through the water in a conspicuous manner, to draw attention to the lure and increase the angler's chances of catching fish.

Scented fish attractants, or scents, have also been developed that increase an angler's efficiency in catching fish. Fish attractants stimulate the olfactory system of a fish and increase effectiveness of the lure. These fish attractants are generally applied to the fishing lure externally before casting the lure into the water. One problem with applying fish attractant to the external surface of the lure is that the fish attractant wears off easily and must be reapplied frequently to maintain its effectiveness.

Finally, attempts have been made to produce a fishing lure that stores fish attractant and releases it during use. However, the prior art is lacking simple and efficient fishing lures that store adequate amounts of fish attractant and release the fish attractant while the lure is pulled through the water. Accordingly, there is a need for a lure that stores sufficient fish attractant for prolonged use, while releasing effective amounts of the fish attractant while moving through the water.

It is an advantage of the present invention to provide a scent-dispensing system for fishing lures that emits a scented fish attractant into the surrounding water while the lure is being pulled through the water.

It is another advantage of the present invention to provide a scent-dispensing system for fishing lures that is effective, refillable, inexpensive, and simple to use.

Therefore, the present invention is hereby presented.

### BRIEF SUMMARY OF THE INVENTION

A scent-dispensing device that dispenses scent while the device is pulled through water comprises a single cylinder of uniform diameter with a first end and a second end A piston is movably positioned within the cylinder, such that when the body is pulled through the water, water enters the first end of the cylinder and causes movement of the piston toward the second end of the cylinder. As the piston moves toward the second end of the cylinder, scent is forced through the second aperture and into the ambient environment.

Optionally, the scent-dispensing device comprises a fill port and exit port that are both fluidly connected to the second end of the cylinder. The fill port can be used to fill the device with fish attractant, and the exit port provides a connection between the second end of the cylinder and the ambient environment. In a device without a fill port, the second end of the cylinder may function as a combination fill port and exit port.

Other embodiments and advantages of the invention will become apparent from the following detailed description taken in conjunction with the drawings.

### BRIEF DESCRIPTION OF THE SEVERAL VIEWS OF THE DRAWINGS

FIG. 1 is a longitudinal cross-sectional view of a scent-dispensing system, in accordance with a preferred embodiment of the present invention.

FIG. 2 is a longitudinal cross-sectional view of a scent-dispensing system, in accordance with a preferred embodiment of the present invention.

FIG. 3 is a longitudinal cross sectional view of a fishing lure incorporating the scent-dispensing system of FIG. 1, in accordance with a preferred embodiment of the present invention.

FIG. 4 is a front view of a piston with o-rings, a screwdriver slot, and a threaded pull aperture, in accordance with a preferred embodiment of the present invention.

FIG. 5a is a side, partially cross-sectional view of a front portion of a second embodiment of a scent-dispensing system, illustrating the piston in the full position.

FIG. 5b is a side, partially cross-sectional view of a rear portion of the scent-dispensing system of FIG. 5a, illustrating the piston in the empty position.

FIG. 6 is a end view of an embodiment of a rear end cap for the scent-dispensing system.

FIG. 7 is a perspective view of the rear end cap of FIG. 6.

FIG. 8 is a side, partially cross-sectional view of a second embodiment of a fishing lure incorporating the scent-dispensing system of FIGS. 5a-5b.

FIG. 9 is a front, partially cross-sectional view of the fishing lure of FIG. 8.

### DETAILED DESCRIPTION OF A PREFERRED EMBODIMENT

Reference will now be made in detail to the present preferred embodiments of the invention as illustrated in the accompanying drawings.

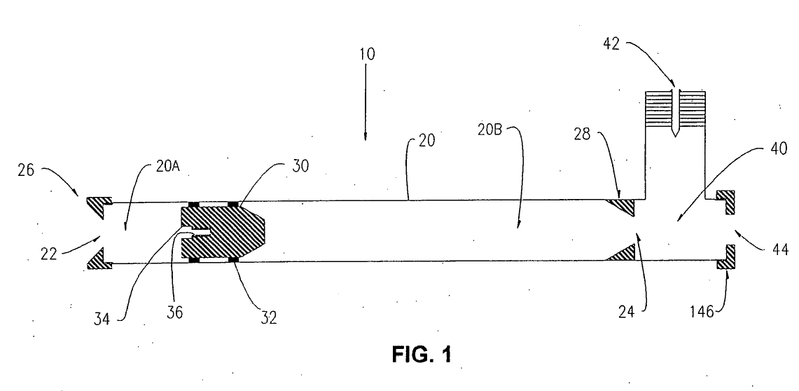

A longitudinal cross-sectional view of a preferred embodiment of a scent-dispensing system (“system”) 10 is illustrated in FIG. 1. In a preferred embodiment, the system 10 comprises a cylinder 20 with a first open end 22 and a second open end 24. The interior of the cylinder 20 houses a piston 30, which can move within the cylinder 20. The second end 24 of the cylinder 20 fluidly connects to a fill and dispensing area 40. The fill and dispensing area 40 additionally connects to a fill port 42 and an exit port 44 with at least one opening. The fill port 42 is used to fill the system 10 with fish attractant. The exit port 44 releases fish attractant into the ambient water.

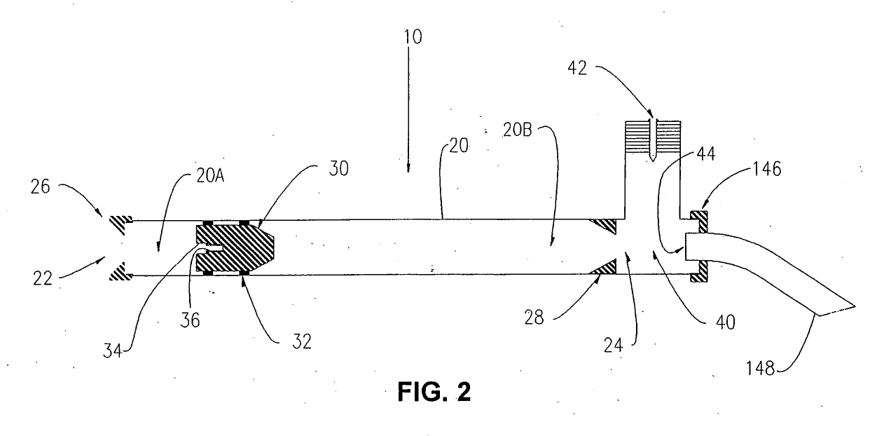

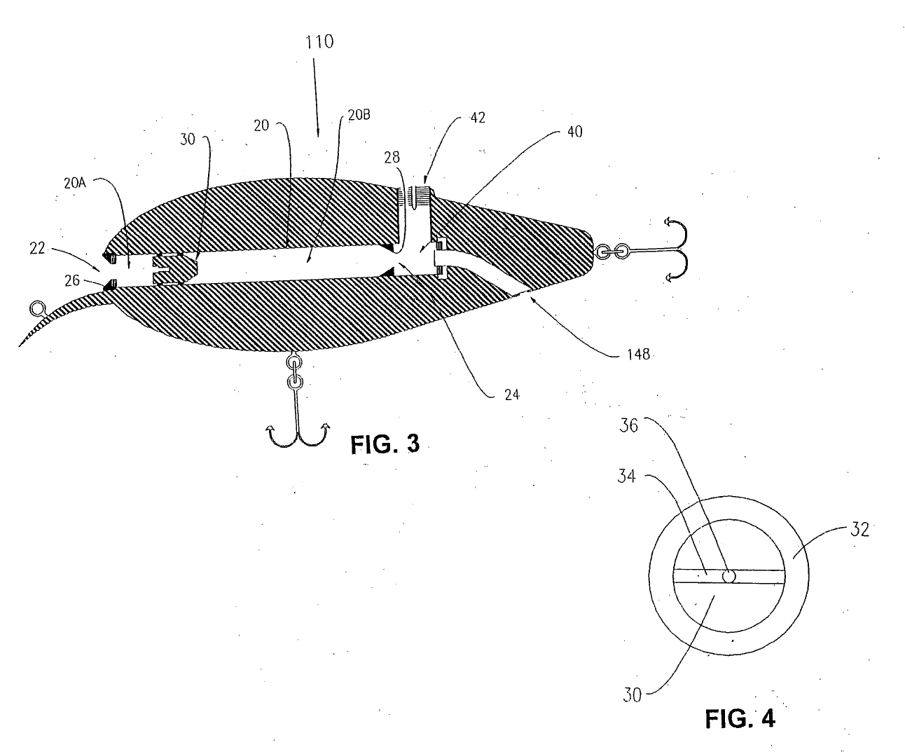

The size and shape of the system 10 can vary in accordance with, inter alia, the size and shape of the fishing lure 110 (see FIG. 3) used in conjunction with the system 10. For example, the length of the cylinder 20 may vary in conjunction with the length of the fishing lure 110. Additionally, as seen in FIGS. 1 and 2, the lengths of the fill port 42 and exit port 44 may vary in conjunction with the width and/or height of the fishing lure 110.

As seen in FIG. 1, a preferred embodiment of a system 10 can be a discrete unit, whereby different fishing lures can be adapted to encompass the system 10. Alternatively, a system 10 can be integrally formed within a fishing lure 110. The system 10 is preferably constructed of a rigid plastic, but any of a plurality of materials are contemplated, including, but not limited to, ceramics and metals. It is to be understood that if the system 10 is integrally formed within a fishing lure, the system 10 can be formed as a cavity in the body of the fishing lure, rather than formed as a discrete unit.

In a preferred embodiment, a fishing lure adapted to hold the system 10 comprises a two-piece body (not shown). The two-piece body may comprise left and right longitudinal members of a fishing lure, with the interior of each member adapted with recesses to accept a longitudinal half of the system 10. Alternatively, the fishing lure may comprise a one-piece body with a cavity therein, or the fishing lure may comprise a body with front and rear members.

In operation, the two members of the fishing lure are attached to each other with the system 10 contained in the interior thereof. When the system 10 is contained within the fishing lure, the first end 22 of the cylinder, the fill port 42, and the exit port 44 are uncovered by the fishing lure body members. The members of the fishing lure can be attached to each other by set-screws, snaps, friction fitting, hinges, or any of a plurality of other mechanical attachments known in the art.

The first end 22 of the cylinder 20 opens to the surrounding environment, and preferably faces the front of the fishing lure 110 and therefore the direction in which the system 10 is pulled through the water. The second end 24 of the cylinder 20 preferably faces the back of the fishing lure 110, and fluidly connects to the fill and dispensing area 40. The fill and dispensing area 40 provides fluidic connections among the cylinder 20, the fill port 42, and the exit port 44. Accordingly, the fill and dispensing area 40 can vary in size and shape according to the size and shape of the fishing lure 110 and the precise locations of the fill port 42 and the exit port 44.

As seen in FIGS. 1-3, a piston 30 is located within the interior of the cylinder 20. A front view of a preferred embodiment of a piston 30 is illustrated in FIG. 4. Preferably, the piston 30 is generally of a cylindrical shape, with a first end that faces the first end of the cylinder 20, and a second end that faces the second end of the cylinder 20. The diameter of the piston 30 may be slightly smaller than the interior diameter of the cylinder 20. In a preferred embodiment, the piston 30 is made of a durable plastic or metal, and, as seen in FIGS. 1-3, can be encompassed by at least one o-ring 32 that contacts the interior surface of the cylinder 20 and provides a slideable surface between the piston 30 and the cylinder 20. The o-ring 32 also prevents fluids on either side of the piston 30 from mixing with fluids on the opposite side of the piston 30 by providing a substantially fluidic seal. However, a piston 30 without o-rings 32 is also contemplated for use within the cylinder 20, whereby the body of the piston 30 would slide within the cylinder 20.

The piston 30 can slideably move in both directions within the cylinder 20. As the piston 30 slides within the cylinder 20, the piston 30 effectively divides the interior of the cylinder 20 into a first chamber 20A and second chamber 20B, such that ambient water in the first chamber 20A does not mix with fish attractant, or scent, in the second chamber 20B. As the piston slides from the first end 22 of the cylinder 20 toward the second end 24 of the cylinder 20, fish attractant is released from the exit orifice 44.

The first end of the piston 30 may optionally comprise a slot 34 or other depression that corresponds to, for example, a screwdriver. If the piston 30 were to get stuck within the cylinder 20, the user can utilize a tool such as a screwdriver to rotate the piston 30 and free it from the bind. Additionally, the first end of the piston may comprise a closed ended threaded aperture 36 that accepts a threaded puller tool. To remove the piston 30 from the cylinder 20, the user would thread a puller tool into the threaded aperture 36 and pull the piston 30 from the cylinder 20.

Although both the first end 22 of the cylinder 20 and the second end 24 of the cylinder 20 are open, respective ends include a means for preventing the piston 30 from exiting the cylinder 20. Preferably, the first end 22 of the cylinder comprises end cap 26 and the second end 24 of the cylinder comprises stop 28 that prevent the piston 30 from exiting respective sides of the cylinder 20. End cap 26 can be any of a plurality of structures that selectively attach to the first end 22 of the cylinder 20. End cap 26 can be attached to the first end 22 of the cylinder by, inter alia, friction fitting or threading. Stop 28 on the second end 24 of the cylinder 20 can be a rim, lip, flange, or decreased interior diameter at the second end 24, whereby the piston 30 cannot pass. In a preferred embodiment, end cap 26 is removable, to enable the piston 30 to be removed from the cylinder 20 when cleaning the system 10.

It is also contemplated that the fishing lure body members, themselves, may slightly overlay the first end 22 of the cylinder 20 and as such provide a means for preventing the piston 30 from exiting the first end of the cylinder 20. In such an embodiment, end cap 26 may be omitted.

A preferred embodiment of a fill port 42 is illustrated in FIG. 1. The fill port 42 enables the user to fill and refill the system 10 with fish attractant. The fill port 42 is fluidly connected to the fill and dispensing area 40, which enables the cylinder 20 to fill when the user injects the fish attractant into the fill port 42. In a preferred embodiment, the fill port 42 comprises a needle valve known in the art, such as the needle valves used with sport balls. Accordingly, the corresponding needle injector (not shown) would be similar to an air inflation needle used to inflate the sport balls. However, other means as are known in the art are contemplated for use as the fill port 42, and therefore can be utilized without deviating from the scope of the present invention.

The location of the fill port 42 can vary with, inter alia, the size and shape of the fishing lure 110, and the desired weight distribution of the fishing lure in relation to the fishing lure's action and movements through the water. In operation, the user injects the fish attractant into the fill port 42, which in turn forces the piston 30 toward the first end 22 of the cylinder 20. When the piston reaches the first end 22 of the cylinder 20, the system 10 is fully loaded with fish attractant and is ready to be cast into the water.

As illustrated in FIGS. 1-2, the system 10 additionally comprises at least one exit port 44 with at least one opening that allows the fish attractant to be released into the ambient water. The exit port 44 fluidly connects to the fill and dispensing area 40, and can be located in any convenient location on the fishing lure 110. In a preferred embodiment, the exit port 44 is located near the back of the fishing lure. The exit port 44 can open directly into the ambient water, or connect to the ambient water via an exit hose 148, as seen in FIG. 2.

Optionally, the fill port 42 can be omitted, whereby the system 10 is filled with scent via the exit port 44. In operation, the user would inject scent into the exit port 44, which would force the piston 30 toward the first end 22 of the cylinder 20. In this embodiment, the fill and dispensing area 40 may omitted. For example, the cylinder 20 can be formed directly through the body of a solid fishing lure, with an end cap 26 selectively attached to the fishing lure at the first end of the cylinder 20, and an exit port 44 or exit cap 146 selectively attached to the fishing lure at the second end of the cylinder.

The size and number of the exit ports 44 can vary with the amount of fish attractant desired to be released in operation. If a user desires more fish attractant to be released while fishing, he or she could select a system 10 and fishing lure 110 with an exit port 44 with a larger sized opening, or select a fishing lure with increased numbers of openings. It is also contemplated that a fishing lure 110 or system 10 may have a plurality of exit ports 44 that can be activated and/or deactivated by the user. Any means as are known in the art can be utilized to accomplish this attribute. For example, a plug or stopper could be utilized to close a particular exit port 44.

As illustrated in FIGS. 1-2, a system 10 or fishing lure 110 may optionally comprise exit cap 146, which includes an exit port 44 with an opening of a predetermined size. Exit cap 146 can be permanently attached to fill and dispensing area 40 by, for example, gluing or thermal welding. Alternatively, exit cap 146 can be removably attached to the fill and dispensing area 40 by, for example, threading or friction fitting. By removably attaching an exit cap 146 to the fill and dispensing area 40, exit caps 146 with different sized exit port 44 openings could be interchangeable on a system 10, thereby providing the user with a means for adjusting the flow of fish attractant into the water.

It is also contemplated that the diameter of any one exit port 44 can be adjustable by, for example, interchangeable opening exit port inserts (not shown) that increase or decrease the diameter of the exit port 44 opening, and therefore adjust the flow of fish attractant into the ambient water. Additionally, the exit port 44 may comprise a pressure valve or membrane that opens as the piston 30 begins to move through the cylinder 20.

In operation, the user inserts a fish attractant injector into the fill port 42. Subsequently, the user injects the fish attractant into the fill and dispensing area 40, which forces the piston 30 to the first end 22 of the cylinder 20 and thereby fills the cylinder 20 with fish attractant. To prevent fish attractant from escaping the exit port 44, the user optionally may place a finger over the exit port 44, or a stopper may be inserted into the exit port 44 temporarily. Once the system 10 is filled with fish attractant, the user removes the injector from the fill port 42, and removes any stoppers from the exit port 44. The user then casts the fishing lure containing the system 10 into the water and begins reeling the fishing lure back toward the user, or trolling the fishing lure.

As the fishing lure is pulled through the water, the piston 30 is forced toward the second end 24 of the cylinder 20. As the piston 30 moves from the first end 22 of the cylinder 20 to the second end 24 of the cylinder 20, fish attractant is expelled from the exit port 44 into the ambient water. As the fish attractant disperses in the water, nearby fish will be stimulated to bite the fishing lure, enhancing the user's chances of catching a fish. Once the piston 30 reaches the second end 24 of the cylinder 20, and the system 10 has exhausted its supply of dispensable fish attractant, the user inserts the injector into the fill port 42, and repeats the process.

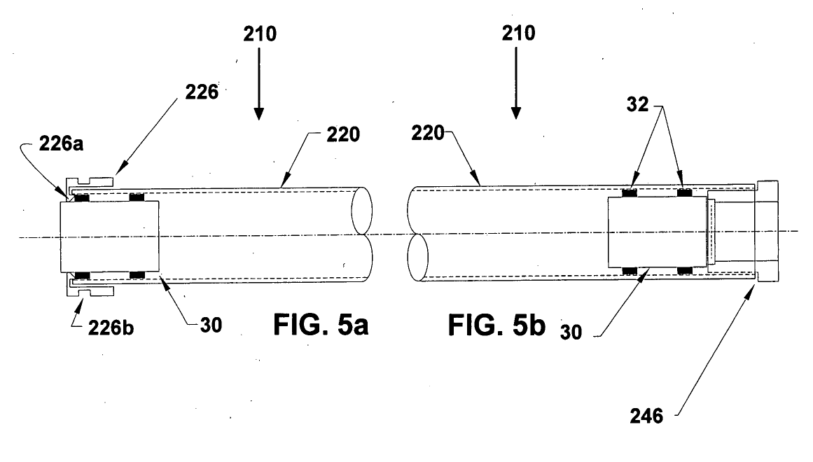

A second embodiment of a scent-dispensing system 210 is illustrated in FIGS. 5a and 5b. FIG. 5a illustrates a side view of the front portion of the scent-dispensing system 210 and FIG. 5b illustrates a side view of the rear portion of the scent-dispensing system 210. The system 210 again comprises a cylinder 220 having a piston 30 therein with optional o-rings 32. The cylinder may have a round or polygonal cross-section.

Scent-dispensing device 210 preferably includes end cap 226 selectively attached to the front end of the cylinder 220, as illustrated in FIGS. 5a and 5b. The end cap 226 may, for example, be permanently attached to the cylinder 20, or removably attached to the cylinder 20 by friction fitting, threading, or any of a plurality of methods known in the art. End cap 226 may include stop portion 226a that prevents the piston 30 from exiting the front of the cylinder 220. Additionally, end cap 226 may include a groove 226b or other equivalent structure such as a projection or other gripping surface that can be utilized by the user's fingers, etc. to remove the scent-dispensing system 210 from a fishing lure.

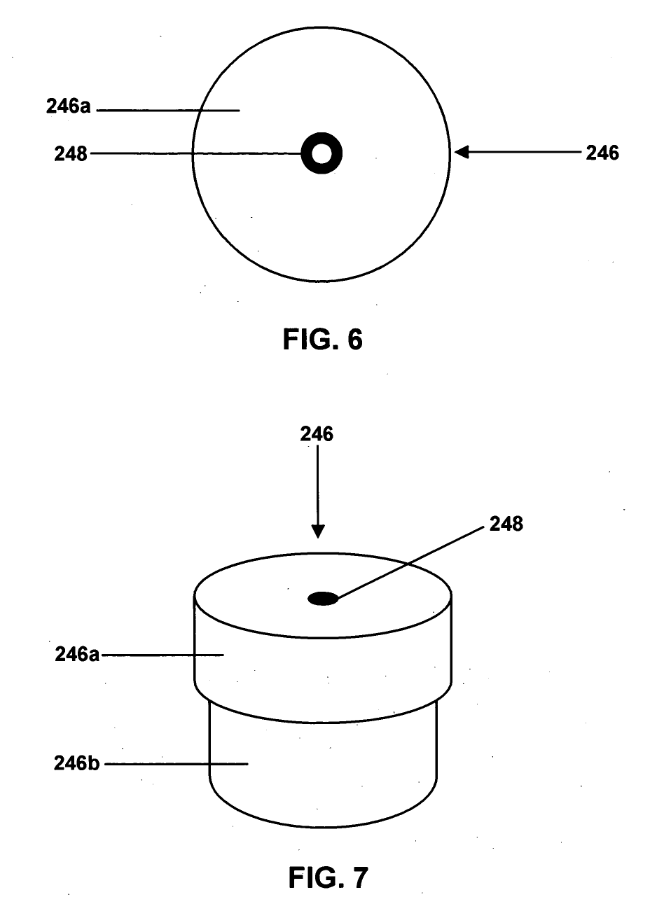

The rear end of cylinder 220 comprises end cap 246 selectively connected to the cylinder 220. End cap 246 may be removably attached to the cylinder 220, permanently attached to the cylinder 220, or integral or monolithic with the cylinder 220. As illustrated in FIGS. 6-7, end cap may have a portion 246b that is received with cylinder 220 and a portion 246a that abuts the end of the cylinder 220. It is contemplated that the portion 246b be frictionally engaged, threadably engaged, or may be engaged in any, of a plurality of the manners with the cylinder 220 to hold the end cap 246 in place. As illustrated in FIGS. 6-7, end cap preferably comprises at least one aperture 248 that extends through the end cap 246 and allows the scent to be released into the water.

The size of the at least one aperture 248 can be selected or adjusted to vary the rate of scent expulsion. As illustrated in FIG. 6, the scent from system 210 is expelled via orifice 348 that is in communication with the rear end of bore 316. The scent-dispensing system could be filled by either by injecting the fish attractant through the aperture 248 or by first removing the end cap 246 and then filling the cylinder with fish attractant.

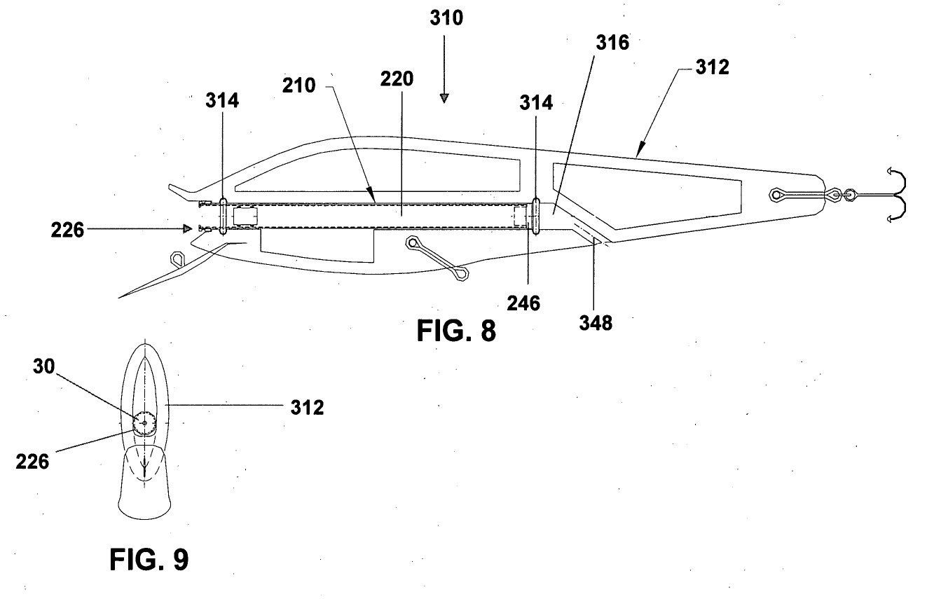

FIGS. 8-9 illustrate a second embodiment of a fishing lure 310, with a scent-dispensing system 210 removably contained therein. The fishing lure may comprise, e.g., a two-piece injection-molded body. In other words, the lure body may be comprised of molded left and right halves joined together. As illustrated in FIGS. 8-9, the fishing lure 310 may comprise a bore 316 or other recess that extends inwardly from the leading end of the lure that receives the scent-dispensing system 210. The bore 316 may generally be described as axially-extending and having an open front end that receives the scent-dispensing system 210. O-rings 314 or any of a plurality of other sealing members may optionally be used to enhance the engagement between the bore 316 and scent-dispensing system 210. The o-rings 314 or other sealing members may be seated in grooves (not numbered) extending around the cylinder 220.

In operation, the user would first remove the scent-dispensing system 210 from the front of the fishing lure 310 by gripping the groove 226b or other structure and pulling the system 210 axially from the front of the fishing lure 310. Next, the user would either inject scented fish attractant into the rear end of the cylinder 220. The user could inject the fish attractant through the aperture 248 in rear end cap 246, or could first remove the end cap 246 and inject or otherwise fill the cylinder 220. The user would next replace the end cap 246, if necessary, and insert the system 210 into the bore 316 in the fishing lure 310. The fishing lure could now be cast into the water and retrieved in an advantageous manner. As the lure is retrieved, the passing water exerts enough force on the piston 30 to force it toward the rear end of the cylinder 220, which forces the fish attractant out orifice 348 in the fishing lure 310. After the system 210 is depleted of scented fish attractant, the user can repeat the process.

The forgoing disclosure is illustrative of the present invention and is not to be construed as limiting thereof. Although one or more embodiments of the invention have been described, persons of ordinary skill in the art will readily appreciate that numerous modifications could be made without departing from the scope and spirit of the disclosed invention. As such, it should be understood that all such modifications are intended to be included within the scope of this invention. The written description and drawings illustrate the present invention and are not to be construed as limited to the specific embodiments disclosed.

1. A scent-dispensing fishing lure, comprising:
a fishing lure body having a bore extending rearwardly from a leading end of the lure body, the bore operable for receiving a scent-dispensing system, and,
a scent-dispensing system removably contained within the bore, the scent-dispensing system being operable for containing a fish attractant and comprising:
a cylinder of generally uniform diameter having a front end and a rear end;
a piston movably positioned within the cylinder; and,
end caps selectively positioned adjacent the front and rear ends of the cylinder to prevent the piston from exiting the cylinder.

2. The scent-dispensing fishing lure of claim 1, wherein,
the rear end cap includes at least one aperture therethrough that selectively allows the fish attractant to exit the cylinder upon movement of the piston toward the rear end of the cylinder.

3. The scent-dispensing fishing lure of claim 1, wherein,
the front end cap comprises a groove around an outer surface thereof to provide gripping surface to aid in removing the cylinder from the lure.

4. The scent-dispensing fishing lure of claim 1, wherein the fishing lure body is formed from two body members.

5. The scent-dispensing fishing lure of claim 4, wherein the two body members comprise left and right halves.

6. The scent-dispensing fishing lure of claim 1, wherein the rear end cap comprises a first portion snugly insertable within the cylinder, and a second portion having a diameter larger than an interior diameter of the cylinder.

7. The scent-dispensing fishing lure of claim 1, further comprising at least one o-ring disposed in an annular groove in the bore, the o-ring engaging an outer portion of the cylinder.

8. The scent-dispensing fishing lure of claim 1, further comprising an exit orifice in the fishing lure body, the exit orifice being in communication with the rear end of the bore.

9. The scent-dispensing fishing lure of claim 8, wherein the exit orifice extends at an angle from the bore.

10. A method of fishing comprising the steps of:
(a) providing a fishing lure comprising:
a fishing lure body having a bore extending rearwardly from a leading end of the lure body, the bore operable for receiving a scent-dispensing system, and,
a scent-dispensing system removably contained within the bore, the scent-dispensing system being operable for containing a fish attractant and comprising:
a cylinder of generally uniform diameter having a front end and a rear end;
a piston movably positioned within the cylinder; and,
end caps selectively positioned adjacent the front and rear ends of the cylinder to prevent the piston from exiting the cylinder;
(b) removing the scent-dispensing system from the bore in the fishing lure by gripping the front end cap and pulling the scent-dispensing system forwardly relative to the fishing lure body;
(c) filling the scent-dispensing system with a fish attractant via the rear end of the piston;
(d) inserting the scent-dispensing system, rear end first, into the bore in the fishing lure body;
(e) placing the fishing lure into water; and
(f) pulling the fishing lure through the water.

11. A scent-dispensing fishing lure that dispenses scent while the fishing lure is pulled through water, comprising:
a fishing lure body with a scent-dispensing device substantially contained therein, the scent-dispensing device comprising:
a single cylinder of uniform diameter with a first end and a second end; and
a piston moveably positioned within the cylinder; wherein,
the cylinder is operable for containing a scented fish attractant between the piston and the second end of the cylinder, and wherein,
when the device is pulled through water, water enters the first end of the cylinder and causes movement of the piston toward the second end of the cylinder, which forces the scented fish attractant to exit the cylinder.

12. The scent-dispensing fishing lure as recited in claim 11, wherein the scent-dispensing device is permanently contained within the fishing lure.

13. The scent-dispensing fishing lure as recited in claim 11, wherein the scent-dispensing device is removably contained within the fishing lure.

14. The scent-dispensing fishing lure as recited in claim 11, wherein the fishing lure body comprises two body members removably attached to each other.

15. The scent-dispensing fishing lure as recited in claim 11, wherein the fishing lure body comprises two body members permanently attached to each other.
